(19) United States
(12) Patent Application Publication
(10) Pub. No.: US 2007/0073493 A1
(43) Pub. Date: Mar. 29, 2007

(54) Method and device for recording operating incidents of medical instruments

(76) Inventor: Jean-Francois Ognier, Orcet (FR)

Correspondence Address: YOUNG & THOMPSON, 745 SOUTH 23RD STREET, 2ND FLOOR, ARLINGTON, VA, 22202, US

(21) Appl. No.: 10/553,409

(22) PCT Filed: Apr. 6, 2004
(86) PCT No.: PCT/FR04/00854

§ 371 Date: Jun. 19, 2006

(30) Foreign Application Priority Data
Apr. 16, 2003 (FR) 03/04765

(51) Int. Cl. G01B 3/44

(52) U.S. Cl. 702/34

(57) ABSTRACT

A method to continuously measure, monitor and record operating parameters of medical appliances especially a medical insufflator, by storing the parameters measured on a pre-determined number of last operating cycles of the appliance, or over a pre-determined sliding operating period of the appliance. If an operating incident is detected, the data recorded at the time of the incident is stored. Furthermore, during the setting-up of the medical instrument, possible malfunctions of essential components are detected and the detected defects of the components are recorded.

This invention relates to a process and a device for implementing this process, for recording operating problems in medical equipment.

Operating problems in medical equipment that can entail hazards to patients or users of this equipment in France generate a posting to the French Agency of Health Safety of Health Products (AFSSAPS) within the framework of a procedure that is called medical device vigilance. This agency can prohibit the use or marketing of equipment that has been subject to problems, and can notify other European Community member countries of this fact under Directive No. 93/42.

All medical devices and equipment that can have a direct or indirect effect on the health of patients are targeted here, such as: intravenous pumps, surgical pumps, circulation pumps outside the body, medical or surgical insufflators, respiratory assistance ventilators, etc. A more specific example is a medical insufflator with automatic control of the gas flow rate that is intended for diagnostic and surgical endoscopy described in the published French Patent Application No. 2 716 627 from the same inventor, or its equivalents such as European Patent No. 0 699 083 and U.S. Pat. No. 5,800,381.

Unfortunately, the conditions under which operating problems occur are very often poorly described, or even poorly identified, and doctors often have a tendency to blame a failure of a medical device to shield themselves from liability.

For this-reason, in roughly 80% of medical device vigilance postings, the actual causes of malfunctions remain unexplained, which leads the AFSSAPS to classify the cases as “unresolved” without, however, drawing a conclusion regarding the safety of the equipment; this allows a presumption of failure to persist.

This situation entails serious consequences in terms of civil liability of the manufacturer of the medical equipment in question and of coverage of this risk by insurance companies.

Admittedly, in other areas of activity, especially in the rail, ground and air transport sectors, recording devices are already in use, such as, for example, aircraft flight parameter recorders, currently called “black boxes.” In this respect, refer, for example, to U.S. Pat. No. 6,392,692. The characteristics and the application of these recorders, however, do not allow direct adaptation to the area of monitoring of medical equipment, such as medical insufflators.

European Patent Application No. EP 1 010 391 also discloses an interactive monitoring device between two microprocessors for driving a medical device; the purpose of this document is not directly the recording of operating problems of a medical device.

Thus, there is still currently a need for specific systems for recording operating problems of medical equipment, and more especially medical insufflators.

This invention intends to provide such a system for purposes of alleviating problems that have been found at present and that are disclosed above.

For this reason, the object of the invention is first of all a process for recording operating problems of a medical device comprised of a medical insufflator, this process consisting essentially in continuously measuring, monitoring, and recording operating parameters of the pertinent medical device, in particular the dynamic or static pressure, by storing the parameters measured over a predetermined number of the last operating cycles of the device or over a “sliding” period of operation of predefined length of this device, and if an operating problem is detected, storing in the memory the data recorded at the instant at which this problem occurs, the recorded data relating to a period extending from before and after the occurrence of the problem, the process also comprising detection of possible malfunctions of the components of this device, and recording of the detected failures of the components when the pertinent medical device is placed in service.

According to the detected type of malfunction of the components, the latter can be indicated to the user and/or can dictate temporary or permanent cessation of the use of the pertinent medical device.

Thus, the process of recording operating problems of medical devices, the object of the invention, makes it possible to monitor two types of events. i.e.:

on the one hand, malfunctions of components that are tested when the medical device is placed in service,

on the other hand, operating problems that occur after the medical device is started up, knowing that this device should not be able to start in a case of a malfunction of a component critical to the safety of the patients or users. Moreover, both component failures detected when the medical device is placed in service and also problems found during operation of this device are stored in a memory, while also recording the time of the stored event. Recording of component failures will also guide post-sales service in the analysis of breakdowns of the medical device under consideration, and recordings of operating problems, stored in a safeguarded manner, will make it possible to definitively establish the conditions of occurrence of each problem, and consequently the responsibility of the doctor and/or of the manufacturer of the medical device. Moreover, in the case of a problem leading to a medical device vigilance notification of the AFSSAPS, the user could be confronted with the fact that no corrective action was taken while he had been notified of a component failure, especially if the recorded date of this failure and of its posting is far in advance of the likewise recorded date of the problem detected and posted to the AFSSAPS.

The objects of the invention, stipulated in the introduction, are thus completely achieved, especially relating to the mandatory posting of operating problems and the conditions of their occurrence.

Moreover, the recordings of failures and the resulting problems for each medical device or category of pertinent medical devices will yield the analysis and findings necessary to the development of this hardware and software for the purpose of improving their operation and their reliability.

One especially advantageous aspect of the process that is the object of the invention is that it guarantees, after start-up of the medical device under consideration, permanent storage of only data relating to anomalies of certain parameters, especially data immediately preceding and following any problem, and that correspond to an interval of several seconds or several tens of seconds; this allows limitation of the size of the memory while benefiting from a maximum of useful data, the data considered “normal” not being stored in the memory.

The object of the invention is also a device for implementing the process of recording operating problems of medical devices, as defined above, which comprises essentially electronic means for measuring operating parameters of the medical device under consideration, relative to a storage unit designed, on the one hand, to store in a “sliding” manner the parameters measured over a predetermined number of the last cycles or over a predefined operating interval of the medical device, and, on the other hand, to permanently store the data acquired at the instant a problem occurs, the device again comprising means of testing components of the medical device under consideration, relative to means of posting failures of components, and with the aforementioned storage unit also intended for recording failures of the components.

This storage unit can be of any known type: EEPROM, hard disk, magnetic tape, etc.

In detailed terms, the device stores the operating parameters measured over the last operating cycles of the medical device under consideration, for example over three to ten cycles, which constitutes constant tracking over a minimum “sliding” period of 10 to 30 seconds. An operating cycle is defined as a sequence of phases of physical measurement of the output data of the medical device, such as the dynamic pressure, static pressure, pressure drop, flow rate, speed, voltage, amperage, etc., and of calculation of the driving parameters of the medical device in order to achieve the setpoint values of various outputs, tracking of the application of new calculated parameters. The stored data will be all the measurement and setting data of the medical device under consideration.

In the case of a problem, the representative values of setting of the medical device and the physical output values of this same medical device are fixed in a part of the storage unit that is only accessible to the engineer or approved monitoring agencies to be recovered preferably within the framework of an adversarial appraisal.

In the case of malfunction of the component, detected when the medical device is placed in service, i.e., when it is supplied with voltage, this malfunction and its date (date on which the failure of the component in question was established for the first time) are recorded. Malfunctions of components critical to safety are indicated to the user by automatic return of the medical device to the “pause” position or to the “wait” mode, with simultaneous display of an error code indicating the nature of the malfunction.

Normal operation of the medical device can only be initiated after preliminary tests of the components have been completed, and in the case of a malfunction of a critical component, the device cannot in principle be started up. However, in order to take into account certain failures of a random or fleeting nature, the medical device can be restarted after it is turned off and on again, of course under the condition that no failure of a component has been established during tests repeated in the course of this restarting. However, such a situation will remain stored in the device, which will thus maintain an outline of it.

The normal operation of the medical device will now be considered, such as develops in the case in which start-up of this medical device has not been prevented by a malfunction of a safety-critical component. The storage unit then intervenes to record possible operating problems, i.e., to store the data present immediately before and immediately after the instant of occurrence of an operating problem, which furthermore triggers an alarm and/or causes shutdown of the medical device, with or without counter-effect.

The data recorded and analyzed here are variable values associated with each setting of the driving device of the medical device, values established during the sequences that generally represent periods that are less than or equal to one second. For a precise idea of the conditions of triggering an operating problem, an analysis period of a minimum of 10 seconds is necessary in practice, this period extending from before and after the occurrence of the problem. This entails, for example, recording the parameters of the five cycles that precede the occurrence of an alarm, and also the parameters of the five cycles that follow the occurrence of the alarm. This recording will also have to be dated with suitable accuracy, on the order of a second.

Beyond the recording of a particular operating problem, as described above, the storage unit of the inventive device must be able to manage a minimum number of recordings of dated problems, for example ten recordings in succession being possible, in order to preserve the outline of these problems even if the doctor considers it essential and without danger to continue his intervention, without interrupting the operation of the medical device.

At the instant of the recording of each problem, the device, in association with the time data (date), stores especially the following:
the setpoint values of different parameters,
the state of different controls of the medical device,
the state of postings during other than the malfunctions of critical components,
values of driving parameters of the medical device,
associated physical measurements during the cycles encompassing the problem.

Moreover, in order to be able to identify the external devices disrupting the operation of the medical device, in the case of a medical insufflator, the physical output measurements of this device and their chronological development in the “wait” mode, for example during the entire alarm phase, should also be stored.

Of course, the number of cycles recorded before and after each problem as well as the number of problems stored in the memory can be modified and adapted to each application in order to enable better relevance of the analysis.

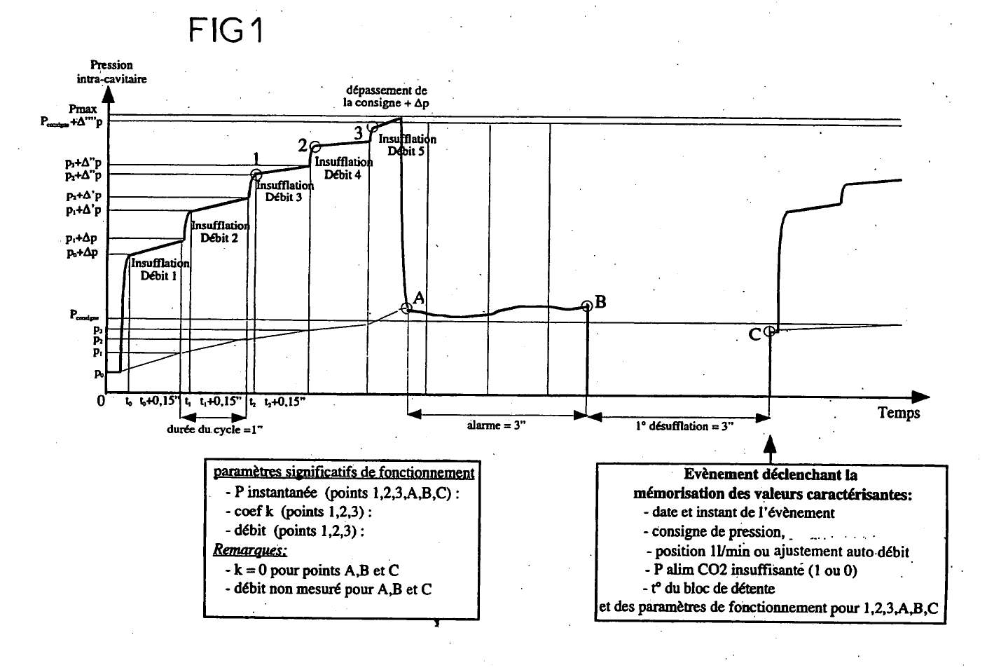

By way of a particular example of application of the invention, the monitoring of operating problems of a medical insufflator such as is the object of the aforementioned French Patent Application No. 2 716 627, with reference to the attached schematic drawing, is considered below. For good understanding of the following, remember that it is an insufflator designed for diagnostic and surgical endoscopy, which includes a circuit for insufflation of a neutral gas such as carbon dioxide into a surgical cavity, a driven pneumatic valve for control of the flow rate with proportional action being provided in this circuit, this valve being electrically motorized. Means of measuring the insufflation pressure are provided at the top of the insufflation circuit, and the pressure within the cavity is calculated based on the measured insufflation pressure via evaluation of the pressure drop of the circuit. A comparison is done between the pressure within the cavity that has been determined in this way, and a setpoint value of this pressure, and the pneumatic valve is controlled as a function of the result of the comparison, in order to constantly provide a minimum gas flow rate that compensates strictly for the escape of gases outside of the surgical cavity. As shown in FIG. 1, which is a diagram of pressure as a function of time, the operation of this insufflator comprises the alternation of insufflation time with a measurement of the dynamic pressure, and a rest time with a measurement of the static pressure or the pressure within the cavity, to be compared to the setpoint pressure. The insufflation time itself is subdivided into a succession of component times, with increasing flow rates, until a value of the dynamic pressure equal to the setpoint pressure increased by a quantity “Δp” is reached.

In the example under consideration, three significant operating parameters are monitored: they are the following, respectively (with reference especially to the diagram of FIG. 1):
the instantaneous dynamic or static pressure P, at points 1, 2, 3, A, B, C;
a coefficient k that is a numerical control factor of the proportional electrical voltage applied to the pneumatic valve of the insufflator, this coefficient being determined at points 1, 2 and 3 (it is zero at points A, B, and C);
the instantaneous gas flow rate D at points 1, 2 and 3 (this flow rate not being measured at points A, B and C).

The instantaneous pressure P and the flow rate D, measured for each setting of the coefficient k, are kept in a “sliding” memory for the last three settings of this coefficient k.

In the case of an alarm with shutdown of insufflation, thus with desufflation, closing of the valve after desufflation causes “frozen” storage of characterizing values and operating parameters for the last three cycles before cessation of insufflation, as well as the instantaneous pressure values after cessation of insufflation, on the opening of the desufflation valve and on its closure.

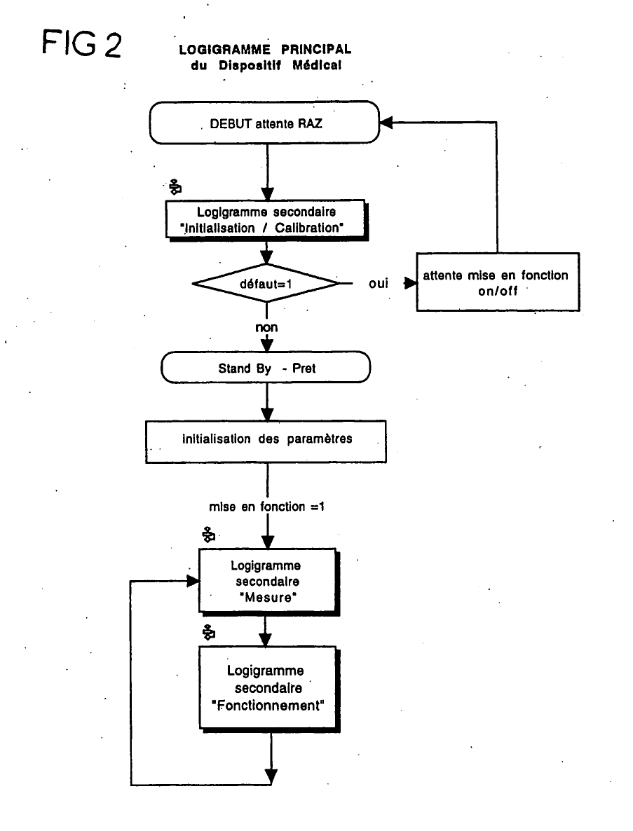

The different functions and phases of operation of the insufflator and of recording failures and problems are also illustrated by the flow charts of the following FIGS. 2 to 5.

The flow chart of FIG. 2 illustrates the general operating loop of the insufflator.

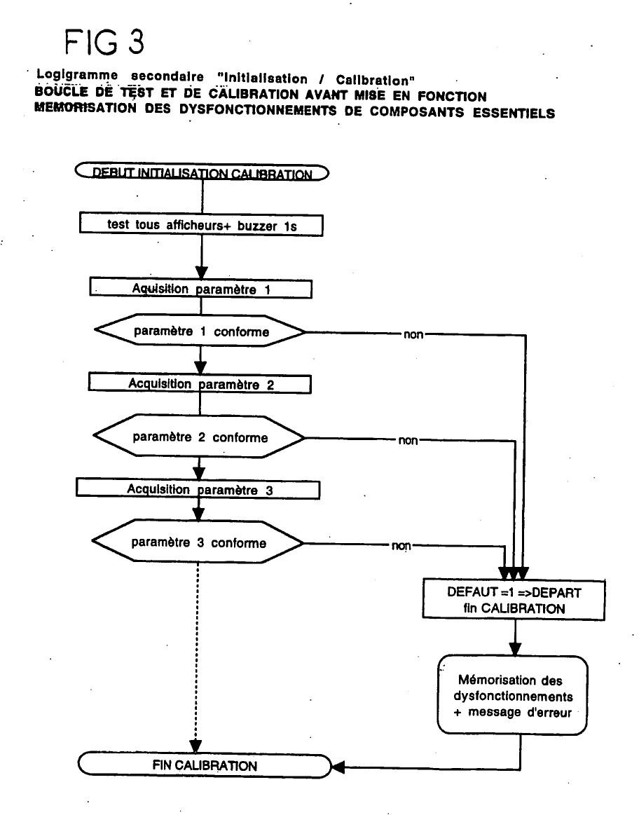

The flow chart of FIG. 3 illustrates the test and calibration loop, carried out before the insufflator is placed in service. Here, it is a matter of testing all the functions and acquiring various data, such as the voltage values (or the value of the aforementioned coefficient k) at the opening of the valve and at the closing of this valve, as well as the values of the hysteresis operating curve of said valve. It is also a matter of calibrating the measurement points of the pressure P and of the flow rate D. This flow chart indicates how, in the start-up phase, the detection of failures of critical components causes failure of the insufflator to start, and storage of the malfunctions, accompanied by an error message.

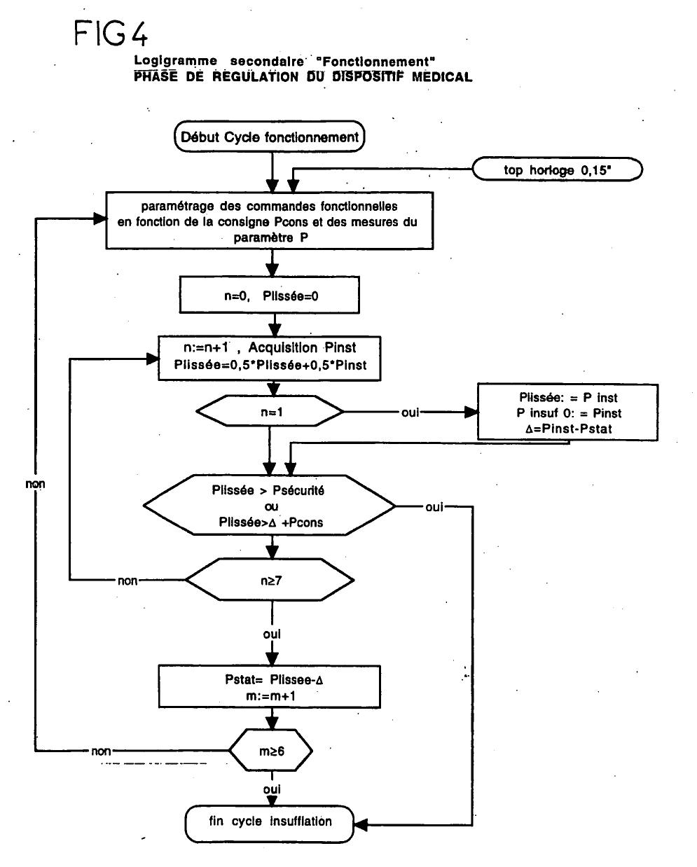

The flow chart of FIG. 4 illustrates the phase of insufflator control in its normal operating cycle. “P smoothed” designates the smoothed value of six pressure measurements, taken at intervals of 0.15 second (in the example under consideration—see also FIG. 1).

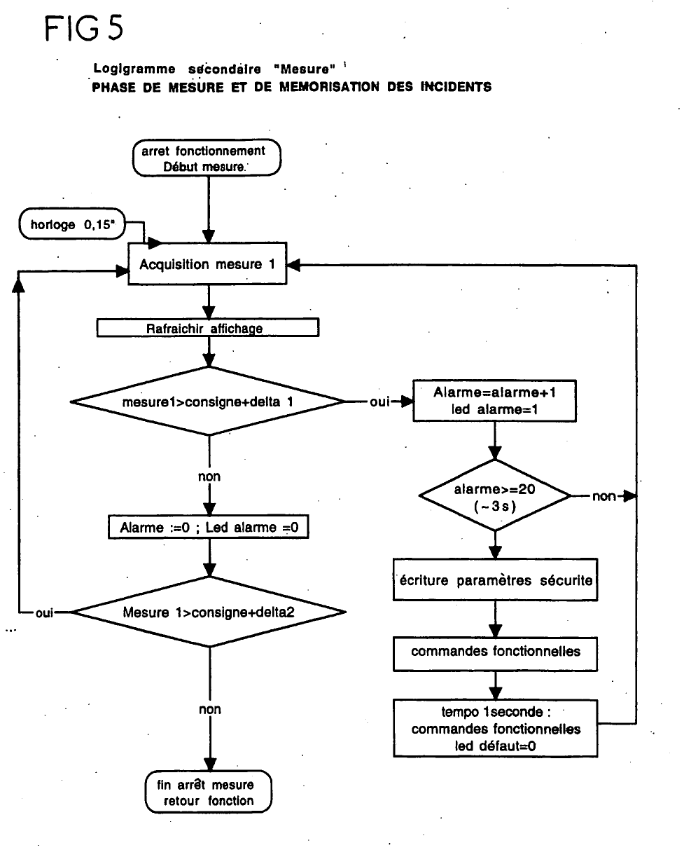

Finally, the flow chart of FIG. 5 illustrates the phase of measurement and storage of operating problems, for one of the monitored parameters, “measurement 1” here designating the instantaneous pressure (measured at six points 1, 2, 3, A, B, C, as indicated above). To understand this latter flow chart, note that:

“delta 1” designates the allowable overpressure before the alarm, varying, for example, from 5 to 10 mm of Hg:

“delta 2” designates the static pressure range before restart of insufflation; for example, insufflation restarts when the static pressure is equal to the setpoint value, reduced by 1 mm of Hg (thus, in this example: delta 2=(−1)).

1. Process for monitoring and recording operating problems of a medical device comprised of a medical insufflator, characterized in that it consists in continuously measuring, monitoring, and recording operating parameters of the pertinent medical device, in particular the dynamic or static pressure, and the gas flow rate, by storing the parameters measured over a predetermined number of the last operating cycles of the device or over a “sliding” period of operation of predefined length of this device, and if an operating problem is detected, storing in the memory the data recorded at the instant at which this problem occurs, the recorded data relating to a period extending from before and after the occurrence of the problem, the process also comprising detection of possible malfunctions of the components of this device, and recording detected failures of the components when the medical device under consideration is placed in service.

2. Process according to claim 1, wherein a malfunction of a component is indicated to the user and/or dictates temporary or definitive prohibition of placing the pertinent medical device in service.

3. Process according to claim 2, wherein malfunctions of components critical to safety are indicated to the user by automatic return of the medical device to the “pause” position or to the “wait” mode, with simultaneous display of an error code indicating the nature of the malfunction.

4. Process according to claim 3, wherein in order to take into account failures of a random or fleeting nature, the medical device is designed to be able to be restarted after it is turned off and on again, this situation, however, remaining stored.

5. Process according to claim 1, wherein the occurrence of a problem in the course of operation of a medical device triggers an alarm and/or causes shutdown of the medical device, with or without counter-effect.

6. Process according to claim 1, wherein at the instant of recording each problem, especially the following are stored in association with the time data:
the setpoint values of different parameters,
the state of different controls of the medical device,
the state of postings during other than the malfunctions of critical components,
values of driving parameters of the medical device,
associated physical measurements during the cycles encompassing the problem.

7. Process according to claim 6, wherein the physical output measurements of the medical device and their chronological development in the “wait” mode, for example during the entire alarm phase, are also stored.

8. Device for recording operating problems of a medical device, for implementing the process according to claim 1, wherein it comprises electronic means of measuring operating parameters of the medical device under consideration, relative to a storage unit designed, on the one hand, to store in a “sliding” manner the parameters measured over a predetermined number of the last cycles or over a predefined operating interval of the medical device, and, on the other hand, to permanently store the data acquired at the instant of occurrence of a problem, and wherein it again comprises means of testing components of the medical device under consideration, relative to means of posting the failures of components, and with the aforementioned storage unit, which is also intended to record the failures of components.

9. Device according to claim 8, wherein the storage unit is designed to manage a minimum number of recordings of dated problems that can occur in succession.
